(19) United States
(12) Patent Application Publication
(10) Pub. No.: US 2008/0295560 A1
(43) Pub. Date: Dec. 4, 2008

(54) Portable Apparatus for Creating Joints in Sheet Metal

(76) Inventor: Jeffrey Hulita, Franklin, WI (US)

Correspondence Address: ABSOLUTE TECHNOLOGY LAW GROUP LLC, 135 W. WELLS ST., SUITE 518, MILWAUKEE, WI, 53203, US

(21) Appl. No.: 12/126,957

(22) Filed: May 26, 2008

Related U.S. Application Data
(60) Provisional application No. 60/940,846, filed on May 30, 2007.

(51) Int. Cl. B21D 11/00; B23P 11/00

(52) U.S. Cl. 72/319; 29/509

(57) ABSTRACT

A method and apparatus for creating joints in sheet metal which includes a stationary member, a slidable center member and slidable rear member with surfaces between the members including z-shaped male and female dies and flat surfaces. The first and second slidable members are compressed to cause the male and females z-shaped die to create a uniformly crimped sheet metal edge, which is further compressed between the flat edges of the stationary and center slidable members to form a joint.

### CROSS-REFERENCE TO RELATED APPLICATIONS

This application claims priority to U.S. Provisional Application No. 60/940/846 filed May 30, 2007.

### FIELD OF INVENTION

This invention relates generally to the field of sheet metal bending and crimping devices, and in particular to a portable device for crimping sheet metal to form joints.

### BRIEF DESCRIPTION OF THE DRAWINGS

FIG. 1 shows a front top perspective view of one embodiment of the apparatus for creating joints in sheet metal.

FIG. 2 shows a front top perspective view of one embodiment of the apparatus for creating joints in sheet metal with an optional stabilizing member in place.

FIG. 3 shows a cross-sectional side view of the top surface of the embodiment of the apparatus for creating joints in sheet metal shown in FIG. 1 along the center line of FIG. 1.

FIG. 4 shows a top view of one embodiment of a stabilizing member for an apparatus for creating joints in sheet metal.

FIG. 5 shows a partial cross-sectional view of the rear along the center line of FIG. 1.

### BACKGROUND

HVAC is an acronym that stands for “heating, ventilating, and air conditioning.” HVAC is important in the design of buildings, and HVAC professionals install heating and cooling components including furnaces and air conditioning.

HVAC professionals generally work with existing ductwork, and create custom sheet metal structures to make the unit installed compatible with existing duct work. Duct work consists of metal structures that carry air flow to and from an HVAC unit. Sheet metal structures are formed to join a new HVAC unit to existing ductwork.

Custom sheet metal structures are generally fabricated in various sizes or dimensions. It is necessary to connect different sized or dimensioned metal components at joints. Joints generally consist of bends in the sheet metal which allow mutiple pieces of sheet metal to connect or interlock in order to provide a continuous structure of a desired length and configuration.

To complete an HVAC installation consisting of multiple interlocking components, multiple joints must be formed at the end portions of the pieces of sheet metal. For example, many metal structures can be connected to form a complete metal duct system. Often sheet metal joints are created at a metal fabrication shop using heavy, non-portable equipment. However, is often necessary and desireable to make modifications and changes at the job site. It is thus desireable for a sheet metal or HVAC worker to have a tool for forming joints in sheet metal which may be used at a job site.

As used herein, “joint” refers to a bend in or along the edge or perimeter of a sheet metal structure which faciliates the joining of one sheet metal structure to another. A joint may be z-shaped, unshaped, c-shaped, s-shaped, w-shaped, accordion shaped or any other shape which allows one piece of sheet metal to be more easily attached, connected, jointed or conformed to another. For example, a joint may include a double-fold along the edge of a piece of sheet metal.

As used herein, the term “transition” means a piece of metal placed between existing ductwork and HVAC unit in an HVAC installation. A transition may also be referred to as custom ductwork.

As used herein, “pre-bent” refers to any structure (e.g., sheet metal) having an angle from 40 to 160 degrees.

As used herein, the term “die” or “die surface” means any structural component used for forming, modifying or shaping metal by force or compression.

For the purpose of promoting an understanding of the present invention, references are made in the text hereof to embodiments of an apparatus for creating joints in sheet metal and method of using same, only some of which are depicted in the figures. It should nevertheless be understood that no limitations on the scope of the invention are thereby intended. One of ordinary skill in the art will readily appreciate that modifications such as the size and shape of the apparatus for creating joints in sheet metal, the inclusion of fewer and/or additional elements, ornamental features, and the inclusion of additional steps in the method of using the apparatus for creating joints in sheet metal are deemed readily apparent and obvious to one of ordinary skill in the art, and all equivalent relationships to those illustrated in the drawings and described in the written description do not depart from the spirit and scope of the present invention. Some of these possible modifications are mentioned in the following description. Therefore, specific details disclosed herein are not to be interpreted as limiting, but rather as a basis for the claims and as a representative basis for teaching one of ordinary skill in the art to employ the present invention in virtually any appropriately detailed system, structure or manner.

It should be understood that the drawings are not necessarily to scale, emphasis instead being placed upon illustrating the principles of the invention. In addition, in the embodiments depicted herein, like reference numerals refer to identical or nearly identical structural elements in the various drawings.

Moreover, the term “substantially” or “approximately” as used herein may be applied to modify any quantitative representation that could permissibly vary without resulting in a change in the basic function to which it is related. For example, one embodiment of the apparatus for creating joints in sheet metal is disclosed herein as requiring that the thightening screws be tightened to forty foot-pounds (40 ft-lbs.). The apparatus for creating joints in sheet metal might permissibly be tightened to slightly greater or less than that amount and still be within the scope of the invention if its functionality is not materially altered. As another example, one embodiment of the apparatus for creating joints in sheet metal is disclosed herein as having a substantially flat top surface. The apparatus for creating joints in sheet metal might differ, allowing the apparatus for creating joints in sheet metal to be used in forming additional shapes and sizes of structures and still be within the scope of the invention if its functionality is not materially altered.

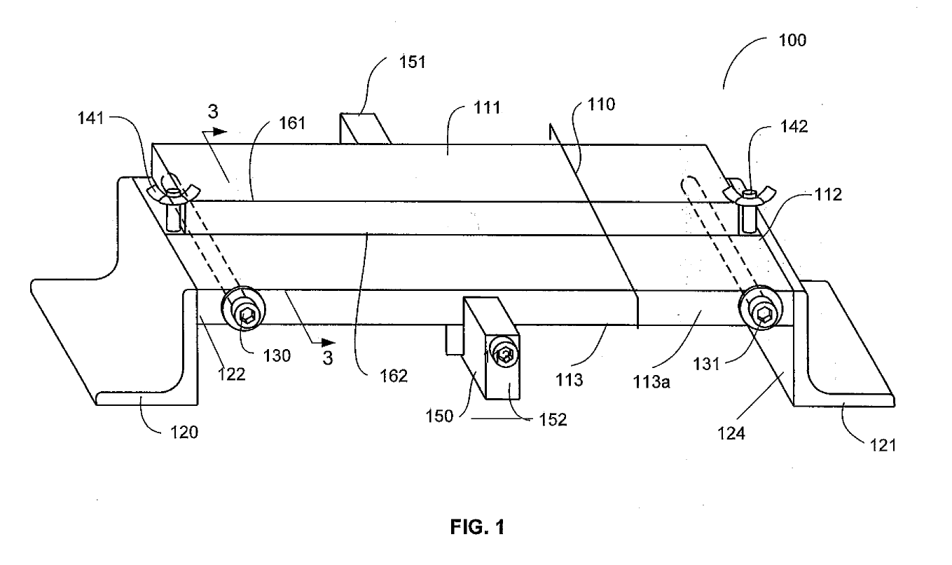

Referring now to the drawings, FIG. 1 shows a front top perspective view of one embodiment of apparatus for creating joints in sheet metal 100 (the sheet metal is not shown). In the embodiment shown, the apparatus for creating joints in sheet metal 100 has a top surface 110 comprised of three (3) separate components: stationary member 113, slidable center member 112, and slidable rear member 111. Stationary member 113 has an outer flat edge 113a and an inner edge 113b which is a female z-shaped die (not shown). Slidable center member 112 has a inner flat edge (not shown) and an inner edge which is a male z-shaped die (not shown). Slidable rear member 111 has an inner flat edge (not shown) and an outer flat edge (not shown). Rear gap 161 is formed between slidable rear member 111 and slidable center member 112, and forward gap 162 is formed between slidable center member 112 and stationary member 113. In the exemplary embodiment shown, slidable rear member 111, slidable center member 112 and stationary member 113 are between 20 inches and 36 inches in length. This is to accommodate varying sizes of sheet metal 100.

Also shown in FIG. 1 are side support members 120 having slot 122 and side support member 121 having slot 124, tightening member 150 and fastening screws 130, 131 and 133. In the emodiment shown, slots 122 and 124 form a track through which slidable center member 112 and slidable rear member 111 can move. In the emodiment shown, slots 122 and 124 are indentations which support slidable rear member 111 and slidable center member 112 while allowing movement by sliding. In other embodiments, slots 122 and 124 may be tracks or hinges. In the embodiment shown, fastening screws 130, 131 and 133 are cap screws, but in other embodiments they may be bolts, screws, nuts, threaded devices or other functionally equivalent components. In the embodiment shown, fastening screws 130, 131 and 133 compress stationary member 113, slidable center member 112, and slidable rear member 111 to compress sheet metal within rear gap 161 and forward gap 162.

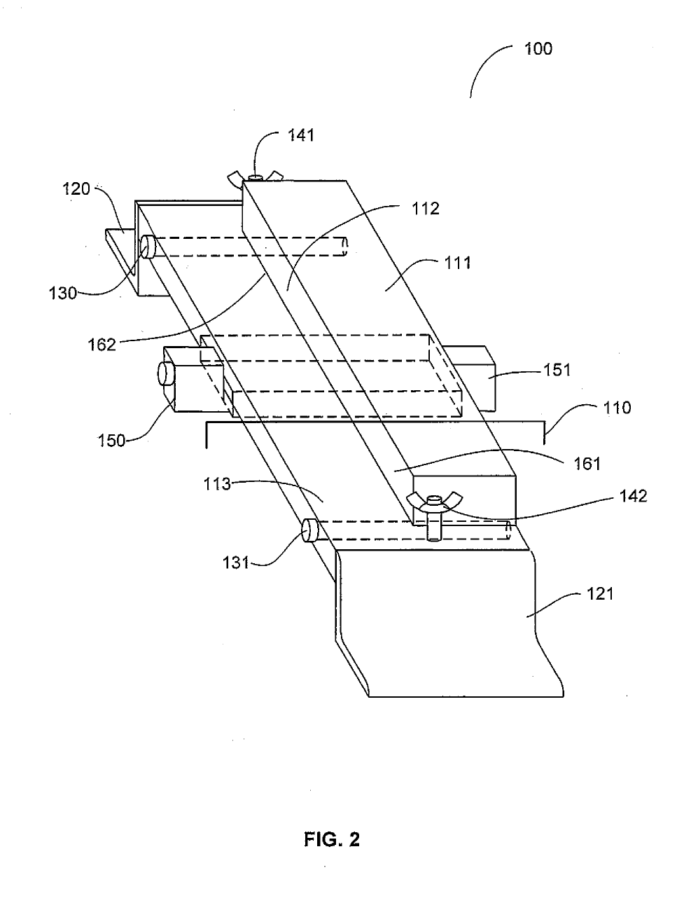

FIG. 2 shows shows a front top perspective view of one embodiment of apparatus for creating joints in sheet metal 100 which also includes optional stabilizing member 180 and wing-nuts 141 and 142 for holding stabilizing member 180 in place. In other embodiments, equivalently functioning screws and bolts may used in place of wing-nuts, bolts; screws, nuts or threaded devices. In still other embodiments, stablilizing member 180 may be permanently attached or may be a structural component of surface 110.

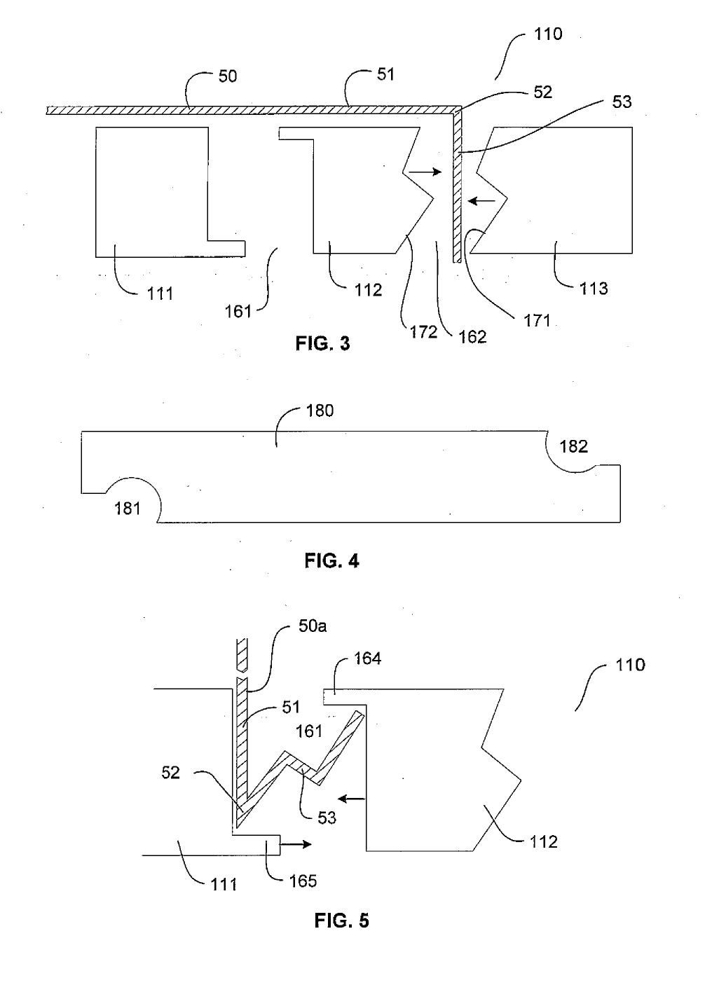

FIG. 3 illustrates a cross-sectional side view of an apparatus for creating joints in sheet metal 100 taken along the center line of surface 110. In the embodiment shown, a joint is formed by inserting pre-bent piece of sheet metal 50 within forward gap 162. The pre-bent piece of sheet metal 50 comprises first side 51 and second side 53, joined at bend 52. Second side 53 of sheet metal 50 is inserted within forward gap 162, and first side 51 lies along the top of the apparatus for creating joints in sheet metal 100. As shown in FIG. 3, stationary member 113 has a Z-shaped die surface 171, and slidable center member 112 has a Z-shaped surface 172. However, in other embodiments the die surface may be u-shaped, c-shaped, s-shaped, w-shaped, accordion shaped or curved.

Referring to FIGS. 1 and FIG. 3 collectively, once sheet metal 50 is inserted within forward gap 162, fastening screws 130, 131 and 133 are tightened to secure sheet metal 50 in place. Stabilizing member 180 can also be placed over sheet metal 50 to keep it flat. Stabilizing member 180 is secured to wing-nuts 141, 142 and fastened with top surface 110 of the apparatus for creating joints in sheet metal 100. FIG. 4 shows a top view of one (1) embodiment of stabilizing member 180. Wingnuts 141, 142 correspond with apertures 181, 182 in slidable center member 112.

Tightening member 150 (shown in FIG. 1) is operated by clamp component 152 and tightening screw 133. Tightenting screw 133 moves clamping component 152 to compress sheet metal 50 between forward gap 162 and gap 161. Tightenting screw 133 is operated either manually or with the use of a wrench, winch, cordless impact drill, power drill or any other apparatus known and used in the art to tighten a screw. When tightening member 150 is operated, one (1) or both of forward member 113 and center member 112 move toward each other. Second side 53 of sheet metal 50 is then pinched between Z-shaped surface 171 of forward member 113 and Z-shaped surface 172 of center member 112, which are complimentary in nature, to create a piece of sheet metal 50 with a substantially Z-shaped second side 53 conforming to the shape of Z-shaped surface 171 of forward member 113 and Z-shaped surface 172 of center member 112 to create crimped sheet metal 50a. Stabilizing member 180 (if used) is removed and tightening member 150 and fastening screws 130, 131 and 133 are then loosened so that sheet metal 50 can be removed from apparatus for creating joints in sheet metal 100. Crimped sheet metal 50a must then be further compressed to form jointed sheet metal 50b (not shown).

FIG. 5 shows a partial cross-sectional view of a segment of the top portion 110 of the embodiment of apparatus for creating joints in sheet metal 100 shown in FIGS. 1 and 2, which portion is used to compress crimped sheet metal 50a to produce jointed sheet metal 50b (not shown). As shown in FIG. 5, rear gap 161 is formed between rear slidable member 111 and center slidable member 112.

Referring to FIG. 1 and FIG. 5 collectively, second side 53 of crimped sheet metal 50a is positioned within rear gap 161. Fastening screws 130, 131 are then tightened to secure crimped sheet metal 50a in place. Tightening screw 133 of tightening member 150 is then operated, either manually or with the use of a power drill or any other apparatus known and used in the art. When tightening screw 133 of tightening member 150 is operated, one (1) or both of center member 112 and rear member 111 move toward each other. Second side 53 of crimped sheet metal 50a (now having the Z-shape) is then pinched between center member 112 and rear member 111. Center member 112 has positioning extension 164 and rear member 111 has positioning extension 165. Positioning extensions 164, 165 maintain second side 53 of crimped sheet metal 50a in a proper position as center member 112 and rear member 111 compress second side 53 of crimped sheet metal 50a to a Z-shaped joint of proper angles. Tightening member 150 and fastening screws 130, 131 and 133 are then loosened so that crimped sheet metal 50a can be removed from the apparatus for creating joints in sheet metal 100. Second side 53 of crimped sheet metal 50a is thus formed of the proper shape and dimensions to function as a joint for mating with other pieces of sheet metal.

While the apparatus for creating joints in sheet metal has been shown and described with respect to several embodiments in accordance with the present invention, it is to be understood that the same is not limited thereto, but is susceptible to numerous changes and modifications as known to a person of ordinary skill in the art, and it is intended that the present invention not be limited to the details shown and described herein, but rather cover all such changes and modifications obvious to one of ordinary skill in the art.

What is claimed is:

1. An apparatus for creating joints in sheet metal comprising:
a stationary member having a male z-shaped die surface and at least one aperture for a tightening screw;
a slidable center member having a female z-shaped die surface, a first flat surface and at least one aperture for a tightening screw;
a slidable rear member having a second flat surface;
a first side support to which said stationary member is fixably attached and having a slot through which said slidable rear member and said slidable center member can slide;
a second side support to which said stationary member is fixably attached and having a slot through which said slidable rear member and said slidable center member are movably attached; and
a tightening clamp which compresses sheet metal between said slidable rear member and said slidable center member, and between said slidable center member and said slidable stationary member.

2. The apparatus of claim 1 wherein said tightening clamp compressed using a screw.

3. The apparatus of claim 1 wherein further including at least one tightening screw are selected from a group consisting of a screw, a threaded component, a wing nut and a bolt.

4. The apparatus of claim 1 which further includes a stabilizing member.

5. The apparatus of claim 4 wherein said stabilizing member is detached.

6. The apparatus of claim 1 which further includes a first gap between said stationary member and said slidable center member into which sheet metal is formed by compression between said female z-shaped die and said male z-shaped die to create crimped sheet metal.

7. The apparatus of claim 1 which further includes a second gap between said slidable center member and said slidable rear member into which crimped sheet metal is compressed to form a joint.

8. The apparatus of claim 1 wherein said tightening clamp is unshaped and fixably attached to said stationary member.

9. The apparatus of claim 7 wherein said tightening clamp further includes an aperture through which a tightening screw is inserted and which compresses a least one gap between said slidable rear member, said slidable center member and said stationary member creating a pressure sufficient to compress sheet metal placed within said at least one gap.

10. The apparatus of claim 1 wherein said slidable rear member, said slidable center member and said stationary member are between 20 and 36 inches long.

11. The apparatus of claim 1 which is capable of being mounted on a structure selected from a group consisting of a table, a cart, a floor and a wall.

12. An apparatus for forming a joint in a piece of sheet metal comprising:
a stationary member having a male z-shaped die surface and at least one aperture for a tightening screw;
a slidable center member having a female z-shaped die surface, a first flat surface and at least one aperture for a tightening screw;
a slidable rear member having a second flat surface and at least one aperture for a tightening screw;
a first side support having a track through which said slidable forward member, said slidable center member, and said slidable rear member can slide;
a second side support having a track through which said slidable forward member, said slidable center member are movably attached, and to which said stationary member is fixably attached.
a tightening clamp which further includes an aperture through which a tightening screw is inserted and which compresses a least one gap between said slidable forward member, said slidable center member and said rear member creating a pressure sufficient to compress sheet metal place within said at least one gap.

13. The apparatus of claim 12 wherein said piece of sheet metal is a pre-bent piece of sheet metal.

14. The apparatus of claim 12 which further includes at least one detached stabilizing component which stabilizes said piece of sheet metal.

15. The apparatus of claim 12 further including a tightening screw selected from a group consisting of a screw, a threaded component, a wing nut and a bolt.

16. The apparatus of claim 12 wherein said slidable rear member, said slidable center member and said stationary member are between 20 and 36 inches long.

17. The apparatus of claim 12 which is capable of being mounted on a structure selected from a group consisting of a table, a cart, a floor and a wall.

18. A method for forming sheet metal comprising:
mounting a stationary component having a female z-shaped die, a slidable center component having a male z-shaped die and a slidable rear component having a first flat surface to a plurality of side support members in a manner which allows said slidable center component and said slidable rear component to move freely to open and close a first and second gap between said stationary member, said center slidable member and said rear slidable member;
inserting sheet metal in said first gap between said stationary component and said sliding component and compressing said slidable center component with a force sufficient to crimp said sheet metal to create a piece of crimped sheet metal;
positioning said piece of crimped sheet metal within said second gap between said second sliding component and said first sliding component to compress said shaped end to create a joint.

19. The method of claim 18 which further includes the step of turning at least one tightening screw to compress said first slidable component, said second slidable component and said stationary component.

20. The method of claim 18 which further include the step of placing a stabilizing member on said piece of sheet metal.
